(19) United States
(12) Patent Application Publication
(10) Pub. No.: US 2012/0214912 A1
(43) Pub. Date: Aug. 23, 2012

(54) USE OF FATTY ACID DERIVATIVES IN BITUMINOUS COMPOSITIONS FOR IMPROVING THEIR RESISTANCE TO CHEMICAL ATTACK AND BITUMINOUS COMPOSITIONS COMPRISING SAID DERIVATIVES

(75) Inventors: Sylvia Harders, Buchholz (DE); Julien Chaminand, Vaulx En Velin (FR)

(73) Assignee: TOTAL RAFFINAGE MARKETING, Puteaux (FR)

(21) Appl. No.: 13/504,829

(22) PCT Filed: Oct. 29, 2010
(86) PCT No.: PCT/IB2010/054916

§ 371 Date: Apr. 27, 2012

(30) Foreign Application Priority Data
Oct. 29, 2009 (FR) 0957627

(51) Int. Cl. C09D 195/00

(52) U.S. Cl. 524/71; 106/284.4

(57) ABSTRACT

The present disclosure relates to the use of at least one fatty acid derivative of general formula (1) in a bituminous composition for improving their resistance to aggressive chemical agents, and in particular to hydrocarbons, such as gasolines, gas oils and/or kerosenes, general formula (1) being:

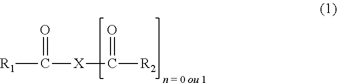

with, when n is equal to 0, an X group chosen from the NH₂ or NHR₃ groups and when n is equal to 1, an X group which represents the —NH—(CH₂)ₘ—NH— group, the R₁, R₂, R₃ groups being, independently of each other, saturated or unsaturated, linear or branched hydrocarbon groups with 8 to 24 carbon atoms, m being between 1 and 8.

### CROSS-REFERENCE TO RELATED APPLICATIONS

This application is a National Phase Entry of International Application No. PCT/IB2010/054916, filed on Oct. 29, 2010, which claims priority to French Patent Application Serial No. 09 57 627, filed on Oct. 29, 2009, both of which are incorporated by reference herein.

### TECHNICAL FIELD

The present invention relates to the use of additives derived from fatty acids in bituminous compositions for improving their resistance to chemical attack. The invention also relates to the bituminous compositions comprising said additives. The invention also relates to the method for preparing said bituminous compositions. The invention finally relates to the mixes comprising said bituminous compositions and aggregates and their preparation method.

### BACKGROUND

It is known to use bituminous compositions, in particular cross-linked bitumen/polymer compositions, as coatings of various surfaces and, in particular, as road coatings, provided that these compositions exhibit in combination a certain number of mechanical characteristics. In order to maintain and/or improve the characteristics and in particular the mechanical properties of a conventional bitumen, bituminous compositions have for a long time been used, in which the bitumen (formed from one or more types of bitumens) is mixed with one or more functional polymers, in particular styrene and butadiene elastomers, these elastomers being optionally chemically cross-linked in situ, optionally using a coupling or cross-linking agent, for example sulphur or at least one of its precursors.

Optimized mechanical characteristics are in particular crucial for road coating applications. In addition to the mechanical properties, in the case of bitumens account should be taken of their susceptibility to certain chemical agents. These aggressive chemical agents can be, for example hydrocarbon solvents, in particular petroleum-based solvents such as kerosenes, gas oils and/or gasolines or also products, in particular fluids, used for de-icing and/or defrosting and/or snow removal from aircraft and from taxiing zones. These fluids are for example aqueous saline solutions of potassium, sodium, magnesium and/or calcium, and/or compositions based on ethylene glycol and/or based on propylene glycol.

The aggressive effect of such chemical agents builds up with the stresses of intense traffic, in particular of heavy vehicles, and bad weather, which has the detrimental effect of increasing the rapid degradation of carriageways, in particular aircraft runways. This susceptibility of the bitumens to these aggressive chemical agents, to chemical attack is more particularly problematic for the bitumens constituting for example tarmacs and the coatings of airport runways, which are made of bituminous mixes (bitumen/aggregates conglomerate). In fact, these airport tarmacs and coatings are frequently soiled by drips of kerosene, during the filling of aircraft tanks, by leaks or other accidental spills of petroleum products. Moreover, they are also exposed to the different fluids used in cold weather to remove ice, frost and/or snow from aircraft and runways.

Service stations as well as industrial tank farms can also be subject to this same problem of the bituminous coatings' resistance to aggressive chemical agents such as hydrocarbon solvents and/or de-icing/defrosting/snow removal fluids. Conventional road carriageways are of course also exposed to this type of chemical attack.

In an attempt to remedy this, it has been proposed to incorporate various additives in bitumens. Thus the patent EP1311619 describes the use of waxes in bitumens for increasing their resistance to hydrocarbons. The waxes are in particular synthetic waxes originating from the Fischer Tropsch synthesis process. Said bitumens can optionally contain polymers which are not cross-linked.

The patent EP1756227 describes bituminous compositions fluxed using a monoalkyl ester of a vegetable oil or of an animal oil. The problem of the bituminous compositions' resistance to chemical attack is not mentioned.

### SUMMARY

The Applicant company was interested in another type of wax and surprisingly discovered that the selection of a very specific category of waxes, in a well-defined range of concentration, made it possible to increase the resistance of the bituminous compositions and of the cross-linked bitumen/polymer compositions to chemical attack, to aggressive chemical agents, in particular to hydrocarbons, such as gasolines, kerosenes and/or gas oils, the increase in resistance to these chemical agents being even more pronounced in the case of the cross-linked bitumen/polymer compositions. Thus the Applicant company noticed that the selection of fatty acid derivatives, corresponding to general formula (1) below, in a bituminous composition at a concentration between 2% and 6% by mass, with respect to the mass of the bituminous composition, made it possible to increase the resistance of the bituminous compositions to chemical attack such as that caused by hydrocarbons such as gasolines, kerosenes and/or gas oils or by de-icing/defrosting/snow removal products. A synergistic effect was also observed in the case of a joint use of fatty acid derivatives of general formula (1) and cross-linked polymer, in particular styrene and butadiene cross-linked copolymer.

General formula (1) is as follows:

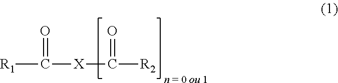

with, when n is equal to 0, an X group chosen from the NH₂ or NHR₃ groups, and when n is equal to 1, an X group which represents the —NH—(CH₂)ₘ—NH— group, the R₁, R₂, R₃ groups being, independently of each other, saturated or unsaturated, linear or branched hydrocarbon groups with 8 to 24 carbon atoms, m being comprised between 1 and 8.

### BRIEF DESCRIPTION

The invention relates to the use of at least one fatty acid derivative in a bituminous composition for improving said bituminous composition's resistance to aggressive chemical agents, the fatty acid derivative having as general formula (1):

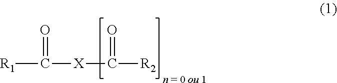

with, when n is equal to 0, an X group chosen from the NH₂ or NHR₃ groups and when n is equal to 1, an X group which represents the —NH—(CH₂)ₘ—NH— group, the R₁, R₂, R₃ groups being, independently of each other, saturated or unsaturated, linear or branched hydrocarbon groups with 8 to 24 carbon atoms, m being comprised between 1 and 8, the quantity of fatty acid derivative of general formula (1) in the bituminous composition being comprised between 2% and 6% by mass, with respect to the mass of the bituminous composition.

Preferably, the quantity of fatty acid derivative of general formula (1) in the bituminous composition is comprised between 2% and 4% by mass, with respect to the mass of the bituminous composition, preferably between 2.5% and 3.5%. Preferably, the bituminous composition comprises a polymer. Preferably, the polymer is a styrene and butadiene copolymer.

Preferably, the styrene and butadiene copolymer has a content of 1,2 double bond units originating from the butadiene comprised between 5% and 50% by mass, with respect to the total mass of the butadiene units, preferably between 10% and 40%, more preferentially between 15% and 30%, even more preferentially between 20% and 25%, %, even more preferentially between 18% and 23%. Preferably, the bituminous composition comprises a cross-linking agent. Preferably, the R₁, R₂, R₃ groups are, independently of each other, saturated or unsaturated, linear or branched hydrocarbon groups with 12 to 22 carbon atoms, preferably of 14 to 20 carbon atoms, more preferentially 16 to 18 carbon atoms, even more preferentially 17 carbon atoms.

Preferably, n is equal to 1. Preferably, m is equal to 2. Preferably, the fatty acid derivative of general formula (1) is ethylene bis-stearamide.

Preferably, the aggressive chemical agents are hydrocarbons, in particular petroleum hydrocarbons, such as kerosenes, gasolines and/or gas oils. Preferably, the aggressive chemical agents are products used for de-icing, defrosting and/or snow removal, such as saline solutions and/or compositions based on ethylene glycol and/or based on propylene glycol. Preferably, the bituminous composition's resistance to aggressive chemical agents is improved when it is used in road applications as a surface layer. Preferably, the bituminous composition's resistance to aggressive chemical agents is improved when it is in a mixture with aggregates in a bituminous mix.

The invention also relates to a cross-linked bitumen/polymer composition comprising at least one bitumen, at least one fatty acid derivative having the general formula (1):

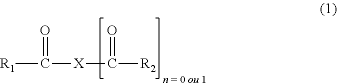

with, when n is equal to 0, an X group chosen from the NH₂ or NHR₃ groups and when n is equal to 1, an X group which represents the —NH—(CH₂)ₘ—NH— group, the R₁, R₂, R₃ groups being, independently of each other, saturated or unsaturated, linear or branched hydrocarbon groups with 8 to 24 carbon atoms, m being comprised between 1 and 8, at least one cross-linked copolymer of an aromatic monovinyl hydrocarbon and a conjugated diene, preferably of styrene and butadiene, the quantity of fatty acid derivative of general formula (1) being comprised between 2% and 6% by mass, with respect to the mass of the cross-linked bitumen/polymer composition, the quantity of aromatic monovinyl hydrocarbon and conjugated diene, preferably styrene and butadiene, copolymer being comprised between 1% and 10% by mass, with respect to the mass of the cross-linked bitumen/polymer composition, said cross-linked bitumen/polymer composition being free of oil of petroleum origin, of oil of vegetable and/or animal origin.

Preferably, the aromatic monovinyl hydrocarbon and conjugated diene, preferably styrene and butadiene, copolymer has a content of 1,2 double bond units originating from the conjugated diene, preferably originating from the butadiene, comprised between 5% and 50% by mass, with respect to the total mass of the conjugated diene units, preferably butadiene, units, preferably between 10% and 40%, more preferentially between 15% and 30%, even more preferentially between 20% and 25%, even more preferentially between 18% and 23%. Preferably, the cross-linked bitumen/polymer composition comprises a cross-linking agent. Preferably, the cross-linked bitumen/polymer composition comprises between 2% and 4% by mass of fatty acid derivative of general formula (1), with respect to the mass of the cross-linked bitumen/polymer composition, preferably between 2.5% and 3.5%.

Preferably, the fatty acid derivative of general formula (1) is ethylene bis-stearamide. Preferably, the cross-linked bitumen/polymer composition comprises between 2% and 8% by mass of aromatic monovinyl hydrocarbon and conjugated diene, in particular styrene and butadiene, copolymer with respect to the mass of the cross-linked bitumen/polymer composition, preferably between 3% and 7%, more preferentially between 4% and 5%.

The invention also relates to a method for preparing a cross-linked bitumen/polymer composition as defined above, in which firstly at least one bitumen, between 1% and 10% by mass of aromatic monovinyl hydrocarbon and conjugated diene, preferably styrene and butadiene copolymer, and at least one cross-linking agent are brought into contact between 120° C. and 220° C., preferably between 140° C. and 200° C., more preferentially between 160° C. and 180° C., for a period of 1 hour to 48 hours, preferably 4 hours to 24 hours, more preferentially 8 hours to 16 hours, the cross-linking agent being able to be omitted when the aromatic monovinyl hydrocarbon and conjugated diene, preferably styrene and butadiene copolymer is the copolymer comprising a particular quantity of 1,2 double bond units originating from the conjugated diene, preferably originating from the butadiene, then between 2% and 6% by mass of fatty acid derivative of general formula (1) is brought into contact between 120° C. and 220° C., preferably between 140° C. and 200° C., more preferentially between 160° C. and 180° C., for a period of 30 minutes to 48 hours, preferably 1 hour to 24 hours, more preferentially 4 hours to 16 hours.

The invention also relates to the use of a bituminous mix comprising the cross-linked bitumen/polymer composition as defined above in a mixture with aggregates. The invention also relates to the method for preparing a bituminous mix as defined above in which the aggregates and the cross-linked bitumen/polymer composition according to any one of claims 15 to 20 are mixed between 120° C. and 220° C., preferably between 140° C. and 200° C., more preferentially between 160° C. and 180° C.

### DETAILED DESCRIPTION

The additives making it possible to improve the bituminous compositions' resistance to chemical attack, and in particular to hydrocarbons, and present in said bituminous compositions according to the invention, are additives of natural origin, and are in particular fatty acid derivatives, and in particular amide derivatives of fatty acids. These additives are represented by general formula (1) below:

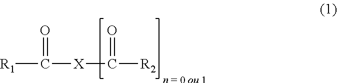

with, when n is equal to 0, an X group chosen from the NH₂ or NHR₃ groups, and when n is equal to 1, an X group which represents the —NH—(CH₂)ₘ—NH— group, the R₁, R₂, R₃ groups being, independently of each other, saturated or unsaturated, linear or branched hydrocarbon groups with 8 to 24 carbon atoms, m being comprised between 1 and 8.

Preferably, the R₁, R₂ and R₃ groups are, independently of each other, saturated or unsaturated, linear or branched hydrocarbon groups with 12 to 22 carbon atoms, preferably 14 to 20 carbon atoms, more preferentially 16 to 18 carbon atoms, even more preferentially 17 carbon atoms. When n is equal to 0, the additive is chosen from the primary amides of general formula R₁—CONH₂ (2) or the secondary amides of general formula R₁—CONH—R₃ (3), the R₁ and R₃ groups being, independently of each other, saturated or unsaturated, linear or branched hydrocarbon groups with 8 to 24 carbon atoms, preferably 12 to 22 carbon atoms, more preferentially 14 to 20 carbon atoms, even more preferentially 16 to 18 carbon atoms, even more preferentially 17 carbon atoms. Among the primary amides of general formula R₁—CONH₂ (2), preferably primary amides in which the R₁ group is a linear or branched, saturated or unsaturated hydrocarbon group with 8 to 24 carbon atoms, preferably 12 to 22 carbon atoms, more preferentially 14 to 20 carbon atoms, even more preferentially 16 to 18 carbon atoms, even more preferentially 17 carbon atoms are used.

There can be mentioned for example erucamide in which R₁ is a linear and unsaturated hydrocarbon group with 21 carbon atoms of formula CH₃—(CH₂), —CH═CH—(CH₂)₁₁—, oleamide in which R₁ is a linear and unsaturated hydrocarbon group with 17 carbon atoms of formula CH₃—(CH₂), —CH═CH—(CH₂)₇—, stearamide in which R₁ is a linear and saturated hydrocarbon group with 17 carbon atoms of formula CH₃—(CH₂)₁₆—, docosanamide in which R₁ is a linear and saturated hydrocarbon group with 21 carbon atoms of formula CH₃—(CH₂)₂₀—. These primary amides are commercially available. Among the secondary amides of general formula R₁—CONH—R₃ (3), secondary amides in which the R₁ and R₃ groups are, independently of each other, saturated or unsaturated, linear or branched hydrocarbon groups with 8 to 24 carbon atoms, preferably 12 to 22 carbon atoms, more preferentially 14 to 20 carbon atoms, even more preferentially 16 to 18 carbon atoms, even more preferentially 17 carbon atoms are preferably used.

There may be mentioned for example oleyl palmitamide in which R₁ is a linear and saturated hydrocarbon group with 15 carbon atoms of formula CH₃—(CH₂)₁₄—and R₃ is a linear and unsaturated hydrocarbon group with 18 carbon atoms of formula CH₃—(CH₂)₇—CH═CH—(CH₂)₈—, stearyl erucamide in which R₁ is a linear and unsaturated hydrocarbon group with 21 carbon atoms of formula CH₃—(CH₂)₇—CH═CH—(CH₂)₁₁— and R₃ is a linear and saturated hydrocarbon group with 18 carbon atoms of formula CH₃—(CH₂)₁₇—. These secondary amides are commercially available.

Preferably, n is equal to 1 and the additive therefore has the general formula R₁—CO—X—CO—R₂ (4) with X being the —NH—(CH₂)ₘ—NH—group where m is comprised between 1 and 8, the R₁ and R₂ groups being, independently of each other, saturated or unsaturated, linear or branched hydrocarbon groups with 8 to 24 carbon atoms, preferably 12 to 22 carbon atoms, more preferentially 14 to 20 carbon atoms, even more preferentially 16 to 18 carbon atoms, even more preferentially 17 carbon atoms. The additives of general formula (4) are the preferred additives.

Preferably, the R₁ and R₂ groups are, independently of each other, linear, saturated or unsaturated hydrocarbon groups comprising 8 to 22 carbon atoms, preferably 12 to 22 carbon atoms, more preferentially 14 to 20 carbon atoms, even more preferentially 16 to 18 carbon atoms, even more preferentially 17 carbon atoms. Preferably, the R₁ and R₂ groups are, independently of each other, linear and saturated hydrocarbon groups comprising 8 to 22 carbon atoms, preferably 12 to 22 carbon atoms, more preferentially 14 to 20 carbon atoms, even more preferentially 16 to 18 carbon atoms, even more preferentially 17 carbon atoms. Preferably, m is comprised between 2 and 6, more preferentially between 3 and 5.

Preferably, when m is equal to 2, the additive then has the general formula R₁—CO—NH—(CH₂)₂—NH—CO—R₂ (5). In this case the R₁ and R₂ groups, are always, independently of each other, saturated or unsaturated, linear or branched hydrocarbon groups with 8 to 24 carbon atoms, preferably 12 to 22 carbon atoms, more preferentially 14 to 20 carbon atoms, more preferentially 16 to 18 carbon atoms, even more preferentially 17 carbon atoms. The additives of general formula (5) are particularly preferred additives.

Preferably, in the general formula R₁—CO—NH—(CH₂)₂—NH—CO—R₂ (5), the R₁ and R₂ groups have the same meaning, which means that the additive has the general formula R₁—NH—CO—(CH₂)₂—NH—CO—R₁ (6). The additives of general formula (6) are the more particularly preferred additives. In this case, R₁ is a linear or branched, saturated or unsaturated hydrocarbon group with 8 to 24 carbon atoms, preferably 12 to 22 carbon atoms, more preferentially 14 to 20 carbon atoms, more preferentially 16 to 18 carbon atoms, even more preferentially 17 carbon atoms. Preferably, R₁ is a linear, saturated or unsaturated hydrocarbon group with 8 to 24 carbon atoms, preferably 12 to 22 carbon atoms, more preferentially 14 to 20 carbon atoms, more preferentially 16 to 18 carbon atoms, even more preferentially 17 carbon atoms. Preferably, R₁ is a linear and saturated hydrocarbon group with 8 to 24 carbon atoms, preferably 12 to 22 carbon atoms, more preferentially 14 to 20 carbon atoms, more preferentially 16 to 18 carbon atoms, even more preferentially 17 carbon atoms.

The preferred additives of general formula (6) are for example ethylene bis-stearamide with R₁ a linear and saturated hydrocarbon group with 17 carbon atoms of formula CH₃—(CH₂)₁₆— or ethylene bis-oleamide with R₁ a linear and unsaturated hydrocarbon group with 17 carbon atoms of formula CH₃—(CH₂),—CH═CH—(CH₂)₇—. These bis-amides are commercially available. Resistance to chemical attack, in particular resistance to petroleum hydrocarbons such as gasolines, gas oils and/or kerosenes, is very clearly improved with ethylene bis-stearamide.

One of the additives (1) to (6) can be used alone or in a mixture in the bituminous compositions. The quantity of additives of general formula (1) to be added to the bituminous compositions is essential to the invention.

Thus, the quantity of additives of general formula (1) is comprised between 2% and 6% by mass, with respect to the mass of the bituminous composition, preferably between 2% and 4%, more preferentially between 2.5% and 3.5%, even more preferentially approximately 3%. The preferred amount of additive of formula (1) is comprised between 2% and 3,5% by weight en masse, with respect to the mass of the bituminous composition. The

Applicant company noticed that a quantity less than 2% by mass of additives of general formula (1) in the bituminous composition did not make it possible to improve the bituminous composition's resistance to chemical attack and in particular to hydrocarbons. Similarly, a quantity greater than 6% by mass of additives of general formula (1), even preferably more than 3.5%, in the bituminous composition, causes a fragility in the bituminous compositions and in particular in the cross-linked bitumen/polymer compositions which become brittle. This results in a deterioration in the elastic recovery, traction and low temperature behaviour properties, for example with respect to the Fraass point. By bituminous composition is meant a bituminous composition comprising bitumen, a bitumen/polymer composition comprising bitumen and a polymer (physical mixture) or a cross-linked bitumen/polymer composition comprising bitumen and a cross-linked polymer within the bitumen.

The bitumen used can be a bitumen obtained from different origins. The bitumen which can be used according to the invention can be chosen from the bitumens of natural origin, such as those contained in deposits of natural bitumen, natural asphalt or bituminous sands. The bitumen which can be used according to the invention can also be a bitumen or a mixture of bitumens originating from the refining of crude oil such as bitumens from direct distillation or bitumens from distillation under reduced pressure or also blown or semi-blown bitumens, residues from deasphalting with propane or pentane, visbreaking residues, these different cuts being able to be alone or in a mixture. The bitumens used can also be bitumens fluxed by adding volatile solvents, fluxes of petroleum origin, carbochemical fluxes and/or fluxes of vegetable origin. It is also possible to use synthetic bitumens also called clear, pigmentable or colourable bitumens. The bitumen can be a bitumen of naphthenic or paraffinic origin, or a mixture of these two bitumens.

The bituminous composition can also comprise at least one polymer. The polymers which can be used according to the invention are the polymers which can be used in a standard fashion in the field of bitumens such as for example the polybutadienes, polyisoprenes, butyl rubbers, polyacrylates, polymethacrylates, polychloroprenes, polynorbornenes, polybutenes, polyisobutenes, polyethylenes, ethylene and vinyl acetate copolymers, ethylene and methyl acrylate copolymers, ethylene and butyl acrylate copolymers, ethylene and maleic anhydride copolymers, ethylene and glycidyl methacrylate copolymers, ethylene and glycidyl acrylate copolymers, ethylene and propene copolymers, ethylene/propene/diene (EP DM) terpolymers, acrylonitrile/butadiene/styrene (ABS) terpolymers, ethylene/acrylate or alkyl methacrylate/glycidyl acrylate or methacrylate terpolymers and in particular ethylene/methyl acrylate/glycidyl methacrylate terpolymer and ethylene/alkyl acrylate or methacrylate/maleic anhydride terpolymers and in particular ethylene/butyl acrylate/maleic anhydride terpolymer.

The preferred polymers are copolymers based on conjugated diene units and aromatic monovinyl hydrocarbon units which can in particular be cross-linked. The conjugated diene is preferably chosen from those comprising 4 to 8 carbon atoms, such as 1,3 butadiene (butadiene), 2-methyl-1,3-butadiene (isoprene), 2,3-dimethyl-1,3-butadiene, 1,3-pentadiene, 1,2-hexadiene, chloroprene, carboxylated butadiene and/or carboxylated isoprene. Preferably, the conjugated diene is butadiene.

The aromatic monovinyl hydrocarbon is preferably chosen from styrene, o-methyl styrene, p-methyl styrene, p-tert-butylstyrene, 2,3 dimethyl-styrene, α-methyl styrene, vinyl naphthalene, vinyl toluene and/or vinyl xylene. Preferably, the monovinyl hydrocarbon is styrene. More particularly, the copolymer consists of one or more copolymers chosen from the aromatic monovinyl hydrocarbon and conjugated diene, in particular styrene and butadiene, copolymers, linear or star-shaped, in diblock, triblock and/or multibranched form, optionally with or without a random hinge, preferably with a random hinge. Preferably, the copolymer is an aromatic monovinyl hydrocarbon and conjugated diene diblock copolymer, in particular a styrene and butadiene diblock copolymer, in particular a styrene and butadiene diblock copolymer having a random hinge.

The aromatic monovinyl hydrocarbon and conjugated diene, in particular styrene and butadiene, copolymer has an average molecular mass M_{W} comprised between 10,000 and 500,000 daltons, preferably between 50,000 and 200,000, more preferentially between 80,000 and 150,000, even more preferentially between 100,000 and 130,000, even more preferentially between 110,000 and 120,000. The molecular mass of the copolymer is measured by GC chromatography with a polystyrene standard according to the standard ASTM D3536.

The aromatic monovinyl hydrocarbon and conjugated diene, in particular styrene and butadiene, copolymer advantageously has a content by weight of aromatic monovinyl hydrocarbon, in particular of styrene ranging from 5% to 50% by mass, with respect to the mass of copolymer, preferably from 20% to 40%. The aromatic monovinyl hydrocarbon and conjugated diene, in particular styrene and butadiene, copolymer advantageously has a content by weight of conjugated diene, in particular butadiene, ranging from 50% to 95% by mass, with respect to the mass of copolymer, preferably from 60% to 80%.

Among the conjugated diene units, a distinction is drawn between the 1,4 double bond units originating from the conjugated diene and the 1,2 double bond units originating from the conjugated diene. By 1,4 double bond units originating from the conjugated diene, is meant the units obtained via a 1,4 addition during the polymerization of the conjugated diene. By 1,2 double bond units originating from the conjugated diene, is meant the units obtained via a 1,2 addition during the polymerization of the conjugated diene. The result of this 1,2 addition is a so-called “pendant” vinyl double bond.

The aromatic monovinyl hydrocarbon and conjugated diene, in particular styrene and butadiene, copolymer has a content of 1,2 double bond units originating from the conjugated diene, in particular originating from the butadiene, comprised between 5% and 50% by mass, with respect to the total mass of the conjugated diene, in particular butadiene, units, preferably between 10% and 40%, more preferentially between 15% and 30%, even more preferentially between 20% and 25%, even more preferentially between 18% and 23%. The aromatic monovinyl hydrocarbon and conjugated diene, in particular styrene and butadiene, copolymer having a content of 1,2 double bond units originating from the conjugated diene, in particular originating from the butadiene as defined above can be used with or without cross-linking agent, as it has the property of being “self cross-linking”, the copolymer branches are cross-linked, linked to each other via these so-called “pendant” vinyl double bonds. The bituminous composition comprises 1% to 10% by mass of polymer, in particular aromatic monovinyl hydrocarbon and conjugated diene, in particular styrene and butadiene, copolymer, with respect to the mass of the bituminous composition, preferably 2% to 8%, even more preferentially 3% to 5%.

The cross-linking of the polymer, in particular of the aromatic monovinyl hydrocarbon and conjugated diene, in particular styrene and butadiene, copolymer, in the bituminous composition, is achieved thanks to the use of a polymer, in particular an aromatic monovinyl hydrocarbon and conjugated diene, in particular a styrene and butadiene, copolymer, as defined above and a cross-linking agent, or thanks to the use of a polymer, in particular an aromatic monovinyl hydrocarbon and conjugated diene, in particular styrene and butadiene, copolymer having a particular quantity of 1,2 double bond units originating from the conjugated diene, in particular butadiene, this quantity of 1,2 double bond units originating from the conjugated diene, in particular butadiene, being comprised between 5% and 50% by mass, with respect to the total mass of the conjugated diene, in particular butadiene, units preferably between 10% and 40%, more preferentially between 15% and 30%, even more preferentially between 20% and 25%, even more preferentially between 18% and 23%, or also thanks to the use of said polymer, in particular the aromatic monovinyl hydrocarbon and conjugated diene, in particular styrene and butadiene, copolymer, having the particular quantity of 1,2 double bond units originating from the conjugated diene, in particular from the butadiene, in combination with a cross-linking agent.

Preferably, the cross-linking agent is chosen from sulphur and the hydrocarbyl polysulphides, alone or in a mixture, optionally in the presence of sulphur-donor or non-sulphur-donor vulcanization accelerators, alone or in a mixture. The sulphur is in particular flowers of sulphur or also alpha crystallized sulphur. The hydrocarbyl polysulphides are for example chosen from the dihexyl disulphides, dioctyl disulphides, didodecyl disulphides, ditertiododecyl disulphides, dihexadecyl disulphides, dihexyl trisulphides, dioctyl trisulphides, dinonyl trisulphides, ditertiododecyl trisulphides, dihexadecyl trisulphides, diphenyl trisulphides, dibenzyl trisulphides, dihexyl tetrasulphides, dioctyl tetrasulphides, dinonyl tetrasulphides, ditertiododecyl tetrasulphides, dihexadecyl tetrasulphides, diphenyl tetrasulphides, orthotolyl tetrasulphides, dibenzyl tetrasulphides, dihexyl pentasulphides, dioctyl pentasulphides, dinonyl pentasulphides, ditertiododecyl pentasulphides, dihexadecyl pentasulphides, dibenzyl pentasulphides or diallyl pentasulphides. The sulphur-donor vulcanization accelerators can be chosen from the thiuram polysulphides, such as for example, the tetrabutylthiuram disulphides, tetraethylthiuram disulphides and tetramethylthiuram disulphides, dipentamethylenethiuram disulphides, dipentamethylenethiuram tetrasulphides or dipentamethylenethiuram hexasulphides.

The non-sulphur-donor vulcanization accelerators which can be used according to the invention can be chosen in particular from mercaptobenzothiazole and its derivatives, dithiocarbamates and derivatives, and thiuram monosulphides and derivatives, alone or in a mixture. There may be mentioned as examples of non-sulphur-donor vulcanization accelerators, zinc 2-mercaptobenzothiazole, zinc benzothiazole thiolate, sodium benzothiazole thiolate, benzothiazyl disulphide, copper benzothiazole thiolate, benzothiazyl N,N′-diethyl thiocarbamyl sulphide and benzothiazole sulphenamides such as 2-benzothiazole diethyl sulphenamide, 2-benzothiazole pentamethylene sulphenamide, 2-benzothiazole cyclohexyl sulphenamide, N-oxydiethylene 2-benzothiazole sulphenamide, N-oxydiethylene 2-benzothiazole thiosulphenamide, 2-benzothiazole dicyclohexyl sulphenamide, 2-benzothiazole diisopropyl sulphenamide, 2-benzothiazole tertiobutyl sulphenamide, bismuth dimethyl dithiocarbamate, cadmium diamyl dithiocarbamate, cadmium diethyl dithiocarbamate, copper dimethyl dithiocarbamate, lead diamyl dithiocarbamate, lead dimethyl dithiocarbamate, lead pentamethylene dithiocarbamate, selenium dimethyl dithiocarbamate, tellurium diethyl dithiocarbamate, zinc diamyl dithiocarbamate, zinc dibenzyl dithiocarbamate, zinc diethyl dithiocarbamate, zinc dimethyl dithiocarbamate, zinc dibutyl dithiocarbamate, zinc pentamethylene dithiocarbamate, dipentamethylene thiuram monosulphide, tetrabutyl thiuram monosulphide, tetraethyl thiuram monosulphide and tetramethyl thiuram monosulphide.

The cross-linking agent can also be chosen from the compounds of general formula HS—R—SH where R represents a saturated or unsaturated, linear or branched hydrocarbon group with 2 to 40 carbon atoms, optionally comprising one or more heteroatoms, such as oxygen. Among the compounds corresponding to this general formula, there can be mentioned for example 1,2 ethanedithiol, 1,3 propanedithiol, 1,4 butanedithiol, 1,5 pentanedithiol, 1,6 hexanedithiol, 1,7 heptanedithiol, 1,8 octanedithiol, bis-(2-mercaptoethyl)ether, bis-(3-mercaptoethyl)ether, bis-(4-mercaptoethyl)ether, (2-mercaptoethyl) (3-mercaptobutyl)ether, (2-mercaptoethyl) (4-mercaptobutyl)ether, 1,8-dimercapto-3,6-dioxaoctane, benzene-1,2-dithiol, benzene-1,3dithiol, benzene-1,4-dithiol or toluene-3,4-dithiol, biphenyl-4,4′-dithiol.

In general a quantity of cross-linking agent between 0.05% and 5% by mass, with respect to the mass of the bituminous composition, preferably between 0.1% and 2%, more preferentially between 0.2% and 1%, even more preferentially between 0.3% and 0.5% is used. Preferably, the quantities of polymer and cross-linking agent are fixed so as to obtain a polymer/cross-linking agent (or styrene and butadiene copolymer/cross-linking agent) ratio comprised between 50:1 and 150:1, preferably between 60:1 and 100:1, more preferentially between 70:1 and 80:1.

The cross-linking of the bituminous compositions can be demonstrated by carrying out on these bituminous compositions, tensile tests according to the standard NF EN 13587. The cross-linked bituminous compositions have a higher tensile strength than the non-cross-linked bituminous compositions. A higher tensile strength results in a high ultimate elongation or maximum elongation (ε max in %), a high rupture stress or maximum elongation stress (σ ε max in MPa), high conventional energy at 400% (E 400% in J/cm²) and/or high total energy (total E in J).

The bituminous compositions, in particular the cross-linked bitumen/polymer compositions, have a maximum elongation, according to the standard NF EN 13587, greater than or equal to 400%, preferably greater than or equal to 500%, more preferentially greater than or equal to 600%, even more preferentially greater than or equal to 700%. The bituminous compositions, in particular the cross-linked bitumen/polymer compositions, have a maximum elongation stress, according to the standard NF EN 13587, greater than or equal to 0.4 MPa, preferably greater than or equal to 0.6 MPa, more preferentially greater than or equal to 0.8 MPa, even more preferentially greater than or equal to 1.2 MPa. The bituminous compositions, in particular the cross-linked bitumen/polymer compositions, have a conventional energy at 400%, according to the standard NF EN 13587, greater than or equal to 3 J/cm², preferably greater than or equal to 5 J/cm², more preferentially greater than or equal to 10 J/cm², even more preferentially greater than or equal to 15 J/cm². The bituminous compositions, in particular the cross-linked bitumen/polymer compositions, have a total energy, according to the standard NF EN 13587, greater than or equal to 1 J, preferably greater than or equal to 2 J, more preferentially greater than or equal to 4 J, even more preferentially greater than or equal to 5 J.

The bituminous composition can also optionally comprise adhesiveness additives and/or surfactants. They are chosen from the alkyl amine derivatives, alkyl polyamine derivatives, alkyl amidopolyamine derivatives, alkyl amidopolyamine derivatives and quaternary ammonium salt derivatives, alone or in a mixture. The most used are the tallow propylene-diamines, tallow amido-amines, quaternary ammoniums obtained by quaternization of tallow propylene-diamines, tallow propylene-polyamines. The quantity of adhesiveness additives and/or surfactants in the bituminous composition according to the invention is comprised between 0.1% and 2% by mass, with respect to the mass of the bituminous composition, preferably between 0.2% and 1° /o.

The bituminous composition, in particular the cross-linked bitumen/polymer composition according to the invention is free of oil of petroleum origin, oil of vegetable origin and/or animal origin as the presence of an oil could alter the bituminous composition's, in particular the cross-linked bitumen/polymer composition's properties of resistance to chemical attack, and in particular to hydrocarbons in the bituminous composition, in particular the cross-linked bitumen/polymer composition by softening the bituminous composition, in particular the cross-linked bitumen/polymer composition too much.

The bituminous composition is prepared by mixing the additive of general formula (1) with the bituminous composition at a temperature of 120° C. to 220° C., preferably 140° C. to 200° C., more preferentially 160° C. to 180° C., for a duration of 30 minutes to 48 hours, preferably 1 hour to 24 hours, more preferentially 2 hours to 16 hours, even more preferentially 4 hours to 8 hours. For the preparation of the cross-linked bitumen/polymer composition, first of all the cross-linked bitumen/polymer composition is prepared without the additive of general formula (1), by mixing the bitumen, the polymer, in particular the aromatic monovinyl hydrocarbon and conjugated diene copolymer, in particular the styrene and butadiene copolymer, and optionally the cross-linking agent at a temperature of 120° C. to 220° C., preferably 140° C. to 200° C., more preferentially 160° C. to 180° C., for a duration of 1 hour to 48 hours, preferably 4 hours to 24 hours, more preferentially 8 hours to 16 hours.

When the bitumen/polymer composition is cross-linked, the additive of general formula (1) is then added to the cross-linked bitumen/polymer composition at a temperature of 120° C. to 220° C., preferably 140° C. to 200° C., more preferentially 160° C. to 180° C., for a duration of 30 minutes to 48 hours, preferably 1 hour to 24 hours, more preferentially 2 hours to 16 hours, even more preferentially 4 hours to 8 hours. The bituminous compositions and the cross-linked bitumen/polymer compositions comprising the additive of general formula (1) are essentially intended for producing bituminous mixes or surface dressings for road applications.

In the case of the bituminous mixes, bituminous compositions and cross-linked bitumen/polymer compositions comprising the additive of general formula (1) are mixed with aggregates in order to provide bituminous mixes which are resistant to chemical attack, in particular resistant to hydrocarbons. The quantity of bituminous composition comprising the additive of general formula (1) in the bituminous mix is comprised between 1 and 10% by mass, with respect to the mass of bituminous mix, preferably between 2 and 8%, more preferentially between 3 and 5%, the remainder being constituted by the aggregates.

The bituminous mixes are used as a surface layer in zones where the surface can come into contact with aggressive chemical agents such as petroleum hydrocarbons or de-icing, defrosting and/or snow removal products, for example, by way of run-offs. Such surfaces include for example car parks, airport tarmacs and runways, service stations, roundabouts, tank farms.

The additive of general formula (1) is used for improving the bituminous compositions' resistance to chemical attack caused by hydrocarbons, in particular petroleum hydrocarbons such as gasolines, fuels, premium fuels, kerosenes, jet fuels, gas oils, diesels. Similarly the additive of general formula (1) is used for improving the bituminous compositions' resistance to chemical attack caused by the de-icing, defrosting and/or snow removal products such as the aqueous saline solutions of potassium, sodium, magnesium and/or calcium, and/or compositions based on ethylene glycol and/or based on propylene glycol. The additive of general formula (1) is particularly effective for improving the bituminous compositions' resistance to hydrocarbons, in particular to petroleum hydrocarbons such as gasolines, kerosenes and/or gas oils.

### EXAMPLES

The bituminous compositions' resistance to hydrocarbons is evaluated according to an internal method similar to the method used for measuring the Ring and Ball temperature of bitumens (EN 1427). The rings filled with bituminous compositions are placed in the supports conventionally used in the EN 1427 method, 5 g balls are placed on these supports. The supports are placed in a beaker filled with kerosene, instead of the water conventionally used in the standard EN 1427 method. The bituminous compositions' resistance to kerosene is evaluated at ambient temperature and under stirring. The duration, softening time of the two bituminous disks is evaluated until each ball, covered with bituminous compositions, moves downwards by (25.0±0.4) mm. The problem arises of the dissolution of the bituminous compositions in kerosene. The liquid in the beaker then becomes opaque, and it is impossible to know visually when the balls drop. We carried out an inspection by taking the supports out at regular time intervals.

Different bituminous compositions are prepared from:
bitumen of penetrability equal to 41 1/10 mm and with a Ring and Ball temperature equal to 51.8° C.,
styrene and butadiene diblock copolymer comprising 25% by mass of styrene, with respect to the mass of the copolymer, and 12% 1,2 double bond units originating from the butadiene, with respect to the mass of butadiene and a molecular mass Mw of 115,000 daltons,
flowers of sulphur,
an additive of general formula (1) in which n is equal to 1, m is equal to 2, R₁ and R₂ are identical and are linear and saturated hydrocarbon groups with 17 carbon atoms (ethylene bis-stearamide), in the quantities in % indicated in Table I below.

TABLE I

| | Bituminous compositions | | | | | | | |
|---|---|---|---|---|---|---|---|---|
| | C₁ | C₂ | C₃ | C₄ | C₅ | C₆ | C₇ | C₈ |
| Bitumen | 100 | 99 | 98 | 97 | 95.9 | 94.9 | 93.9 | 92.9 |
| SB Copolymer | — | — | — | — | 4 | 4 | 4 | 4 |
| Sulphur | — | — | — | — | 0.1 | 0.1 | 0.1 | 0.1 |
| Ethylene | — | 1 | 2 | 3 | — | 1 | 2 | 3 |
| bis-stearamide | | | | | | | | |

The bituminous compositions are prepared as follows: For the bituminous compositions C₂ to C₄, a bitumen is introduced into a reactor maintained at 185° C. under stirring at 300 rpm. The content of the reactor is maintained at 185° C. under stirring at 300 rpm for 10 minutes. The additive of general formula (1) is then introduced into the reactor. The content of the reactor is maintained at 185° C. under stirring at 300 rpm for 1 hour.

For the cross-linked bitumen/polymer composition C₅, the bitumen and the styrene/butadiene SB copolymer is introduced into a reactor maintained at 185° C. and under stirring at 300 rpm. The content of the reactor is then maintained at 185° C. under stirring at 300 rpm for 4 hours. Flowers of sulphur are then introduced into the reactor. The content of the reactor is maintained at 185° C. under stirring at 300 rpm for 2 hours, then at 185° C. and under stirring at 150 rpm for 12 hours. For the cross-linked bitumen/polymer compositions C₆ to C₈, the same procedure is followed and the additive of general formula (1) is then introduced into the reactor. The content of the reactor is maintained at 185° C. under stirring at 300 rpm for 1 hour.

The compositions C₂ to C₄ correspond to bituminous compositions constituted by bitumen and an additive according to general formula (1). The bituminous composition C₁ is a control bituminous composition comprising bitumen alone, and no additive according to general formula (1). The bituminous composition C₂ is a control bituminous composition comprising only 1% by mass of additive according to general formula (1). The bituminous compositions C₃ and C₄ are bituminous compositions according to the invention comprising 2% or 3% by mass of additive according to general formula (1).

The compositions C₆ to C₈ correspond to c linked bitumen/polymer compositions constituted by bitumen, an additive according to general formula (1) and a cross-linked styrene and butadiene copolymer. The bituminous composition C₅ is a control cross-inked bitumen/polymer composition comprising no additive according to general formula (1). The cross-linked bitumen/polymer composition C₆ is a control composition comprising only 1% by mass of additive of general formula (1). The cross-inked bitumen/polymer compositions C₇ and C₈ are cross-linked bitumen/polymer compositions according to the invention comprising 2% or 3% by mass of additive according to general formula (1).

For the bitumen/polymer compositions C₁, to C₈, the following characteristics are determined:

⁽¹⁾ penetrability at 25° C. denoted P₂₅ ( 1/10mm) measured according to the standard EN 1426,

⁽²⁾ Ring and Ball temperature denoted RBT (° C.) measured according to the standard EN 1427,

⁽³⁾ Pfeiffer index denoted PI defined by the formula below:

$$PI = \frac{1952 - 500 \times log ( {P}_{25} ) - 20 \times RBT}{50 \times log ( {P}_{25} ) - RBT - 120}$$

⁽⁴⁾ elastic recovery denoted ER (%) measured at 25° C. according to the standard NF EN 13398,

⁽⁵⁾ the time necessary for the ball to move down (25.0±0.4) mm,

The results are given in Table II below:

TABLE II

| | Bituminous compositions | | | | | | | |
|---|---|---|---|---|---|---|---|---|
| | C₁ | C₂ | C₃ | C₄ | C₅ | C₆ | C₇ | C₈ |
| P₂₅ | 41 | 35 | 29 | 25.2 | 28.4 | 23.3 | 26 | 25.7 |
| (1/10 mm) | | | | | | | | |
| RBT (° C.) | 51.8 | 62 | 83 | 100.5 | 74.0 | 74.0 | 86.4 | 97.0 |
| PI | −1.19 | 0.57 | 3.38 | 5.04 | 2.09 | 1.68 | 3.56 | 4.72 |
| ER (%) | — | — | — | — | 82 | 80 | 69 | 57 |
| Time | 30 | 40 | 7 h | 11 h | 1 h | 1 h | 10 h | 18 h |
| | min | min | | | 30 | 30 | | |

It is noted that the resistance to kerosene of the bituminous compositions C₃ and C₄ is very clearly improved when 2% or 3% by mass of additive of general formula (1) is added to the bituminous composition C₁. The resistance to kerosene is 7 hours for the bituminous composition C₃ and 11 hours for the bituminous composition C₄ whereas it is only 40 minutes for the bituminous composition C₂ comprising 1% by mass of additive of general formula (1).

It is also noted that the resistance to kerosene of the cross-linked bitumen/polymer compositions C₇ and C₈ is very clearly improved when 2% or 3% by mass of additive of general formula (1) is added to the cross-linked bitumen/polymer composition C₅. The resistance to kerosene is 18 hours for the cross-linked bitumen/polymer composition C₈ and 10 hours for the cross-linked bitumen/polymer composition C₇, whereas it is only 1 hour and 30 minutes for the cross-linked bitumen/polymer composition C₆ comprising 1% by mass of additive of general formula (1). Hydrocarbon resistance tests are also carried out on bituminous mixes according to the standard EN12697-43.

The bituminous mixes E₁, E₄, E₅ and E₈ comprise respectively 5.6% by mass of bituminous composition C₁, C₄, C₅ or C₈, with respect to the mass of the bituminous mix, and 94.4% by mass of aggregates (composition of the aggregates: 38% by mass of 6/10 aggregates, with respect to the mass of the aggregates, 5% by mass of 4/6 aggregates, 5% by mass of 2/4 aggregates, 48% by mass of 0/2 sand and 4% by mass of fillers, content of spaces 8.5-9.5%). The mixes are prepared by mixing the bituminous compositions and aggregates at 180° C.

The tests are carried out according to the standard EN12697-43 in gas oil and kerosene. The results are given in Table III below:

TABLE III

Bituminous mixes

| | E₁ | E₄ | E₅ | E₈ |
|---|---|---|---|---|
| Resistance to gas oil 24 h (A/B) | 5/4 | 1/2 | 3/3 | 1/3 |
| Resistance to gas oil 72 h (A/B) | — | 1/5 | 4/7 | 1/5 |
| Resistance to kerosene | 13/11 | 2/4 | 6/5 | 1/4 |
| 24 h (A/B) | | | | |
| Resistance to kerosene | — | 1/10 | 9/10 | 3/8 |
| 72 h (A/B) | | | | |

It is noted that the bituminous mix E4 is more resistant to gas oil and kerosene than the bituminous mix E₁, all the A and B values of the bituminous mix E₄ being less than those of the bituminous mix E₁. The addition of 3% by mass of additive of general formula (1) in pure bitumen has therefore very clearly improved the resistance of the pure bitumen to gas oil and kerosene.

It is noted that the bituminous mix E₈ is more resistant to gas oil and kerosene than the bituminous mix E₅, all the A and B values of the bituminous mix E₆ being less than or equal to those of the bituminous mix E₅. The addition of 3% by mass of additive of general formula (1) to a cross-linked bitumen/polymer composition has therefore improved the resistance of the cross-linked bitumen/polymer composition to gas oil and kerosene.

1-23. (canceled)

24. A method for improving the resistance of a bituminous composition to aggressive chemical agents, the method comprising adding at least one fatty acid derivative in the bituminous composition wherein the fatty acid derivative has the general formula (1): 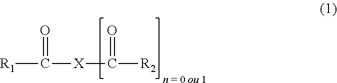
with, when n is equal to 0, an X group chosen from the NH₂ or NHR₃ groups and when n is equal to 1, an X group which represents the —NH—(CH₂)ₘ—NH—group, the R₁, R₂, R₃ groups being, independently of each other, saturated or unsaturated, linear or branched hydrocarbon groups with 8 to 24 carbon atoms, m being comprised between 1 and 8, wherein the quantity of fatty acid derivative of general formula (1) in the bituminous composition being comprised between 2% and 6% by mass, with respect to the mass of the bituminous composition.

25. The method according to claim 24 in which the quantity of fatty acid derivative of general formula (1) in the bituminous composition is comprised between 2% and 4% by mass, with respect to the mass of the bituminous composition.

26. The method according to claim 24 in which the bituminous composition comprises a polymer.

27. The method according to claim 26 in which the polymer is a styrene and butadiene copolymer.

28. The method according to claim 27 in which the styrene and butadiene copolymer has a content of 1,2 double bond units originating from the butadiene, comprised between 5% and 50% by mass, with respect to the total mass of the butadiene units.

29. The method according to claim 26 in which the bituminous composition comprises a cross-linking agent.

30. The method according to claim 24 in which the R₁, R₂, R₃ groups are, independently of each other, saturated or unsaturated, linear or branched hydrocarbon groups with 12 to 22 carbon atoms.

31. The method according to claim 24 in which the fatty acid derivative of general formula (1) is ethylene bis-stearamide.

32. The method according to claim 24 in which the aggressive chemical agents are hydrocarbons.

33. The method according to claim 24 in which the aggressive chemical agents are products used for de-icing, defrosting and/or snow removal and/or compositions based on ethylene glycol and/or based on propylene glycol.

34. The method according to claim 24 further comprising placing the bituminous composition in road applications as a surface layer.

35. The method according to claim 24 further comprising mixing the bituminous composition with aggregates in a bituminous mix.

36. A cross-linked bitumen/polymer composition comprising at least one bitumen, and at least one fatty acid derivative having the general formula (1): 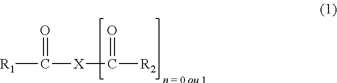
with, when n is equal to 0, an X group chosen from the NH₂ or NHR₃ groups and when n is equal to 1, an X group which represents the —NH—(CH₂)ₘ—NH—group, the R₁, R₂, R₃ groups being, independently of each other, saturated or unsaturated, linear or branched hydrocarbon groups with 8 to 24 carbon atoms, m being comprised between 1 and 8, at least one cross-linked copolymer of an aromatic monovinyl hydrocarbon and a conjugated diene, the quantity of fatty acid derivative of general formula (1) being comprised between 2% and 6% by mass, with respect to the mass of the cross-linked bitumen/polymer composition, the quantity of aromatic monovinyl hydrocarbon and conjugated diene, being comprised between 1% and 10% by mass, with respect to the mass of the cross-linked bitumen/polymer composition, said cross-linked bitumen/polymer composition being free of oil of petroleum origin, oil of vegetable and/or animal origin.

37. The cross-linked bitumen/polymer composition according to claim 36 in which the aromatic monovinyl hydrocarbon and conjugated diene copolymer has a content of 1,2 double bond units originating from the conjugated diene, comprised between 5% and 50% by mass, with respect to the total mass of the conjugated diene.

38. The cross-linked bitumen/polymer composition according to claim 36 comprising a cross-linking agent.

39. The cross-linked bitumen/polymer composition according to claim 36 comprising between 2% and 4% by mass of fatty acid derivative of general formula (1), with respect to the mass of the cross-linked bitumen/polymer composition.

40. A cross-linked bitumen/polymer composition according to claim 36 in which the fatty acid derivative of general formula (1) is ethylene bis- stearamide.

41. The cros-linked bitumen/polymer composition according to claim 36 comprising between 2% and 8% by mass of aromatic monovinyl hydrocarbon and conjugated diene, copolymer with respect to the mass of the cross-linked bitumen/polymer composition.

42. A method for preparing a cross-linked bitumen/polymer composition according to claim 36 in which firstly at least one bitumen, between 1% and 10% by mass of aromatic monovinyl hydrocarbon and conjugated diene, and at least one cross-linking agent are brought into contact between 120° C. and 220° C., for a period of 1 hour to 48 hours, the cross-linking agent being able to be omitted when the aromatic monovinyl hydrocarbon and conjugated diene, is the copolymer according to claim 16, then between 2% and 6% by mass of fatty acid derivative of general formula (1) is brought into contact between 120° C. and 220° C., for a period of 30 minutes to 48 hours.

43. A bituminous mix comprising the cross-linked bitumen/polymer composition according to claim 36 in a mixture with aggregates.
